(19) United States
(12) Patent Application Publication
(10) Pub. No.: US 2002/0168903 A1
(43) Pub. Date: Nov. 14, 2002

(54) Quick-fastening device

(76) Inventors: Winrich Habedank, Leimen (DE); Klaus-Peter Eppe, Waldbrunn (DE); Ralf Weber, Heidelberg (DE)

Correspondence Address: LERNER AND GREENBERG P.A., Post Office Box 2480, Hollywood, FL, 33022-2480, US

(21) Appl. No.: 10/122,522

(22) Filed: Apr. 11, 2002

(30) Foreign Application Priority Data
Apr. 11, 2001 (DE) 101 18 099.3

(51) Int. Cl. H01R 9/26

(52) U.S. Cl. 439/716

(57) ABSTRACT

A description is given of a quick-fastening device for fixing an installation unit on a carrying-rail configuration. The carrying-rail configuration has a carrier plate and a hat-profile rail. Integrally formed on the carrier plate is a resilient snap-action hook with a nose that is oriented in the direction of the hat-profile carrying rail and is snapped into one depression on the narrow side wall of the installation unit.

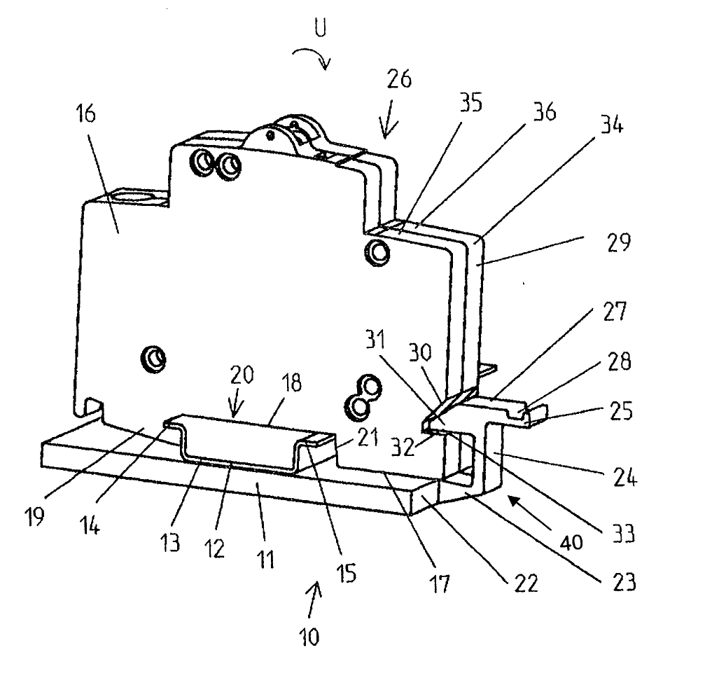

### BACKGROUND OF THE INVENTION

### FIELD OF THE INVENTION

The invention relates to a quick-fastening device having an installation unit fixed on a carrier plate having a hat-profile rail.

European Patent Application EP 0 821 454 discloses a connection device for electrical installation units which contains a carrier plate and a hat-profile carrying rail connected thereto; busbars are located within the carrier plate, which is configured as a housing. If the installation unit which has a recess with a movable nose and a fixed nose on the fastening side is snapped onto the hat-profile carrying rail, then the fixed nose engages behind a longitudinal edge of the hat-profile carrying rail and, by virtue of the installation unit being pivoted about the contact point between the nose and longitudinal edge of the hat-profile carrying rail, it is possible, if a movable nose is actually present, for the movable nose to latch behind the other longitudinal edge of the hat-profile carrying rail. In the case of the configuration described in European Patent Application EP 0821 454, downwardly projecting connection lugs are located on the fastening side of the installation unit, the lugs being plugged-connected to the busbars located within the housing.

### SUMMARY OF THE INVENTION

It is accordingly an object of the invention to provide a quick-fastening device that overcomes the above-mentioned disadvantages of the prior art devices of this general type.

With the foregoing and other objects in view there is provided, in accordance with the invention, a quick-fastening device. The device contains an installation unit having narrow side walls with a depression formed in one of the narrow side walls, a carrying-rail configuration having a carrier plate and a hat-profile rail fastened on the carrier plate, and a resilient snap-action hook integrally formed on the carrier plate. The resilient snap-action hook has a nose oriented in a direction of the hat-profile carrying rail and snaps in behind the depression in the installation unit.

According to the invention, the quick-fastening device is thus characterized in that integrally formed on the carrier plate is a resilient snap-action hook with a hook nose which is oriented in the direction of the hat-profile rail and can be snapped in behind a depression on the narrow side wall of the installation unit.

According to an advantageous configuration of the invention, the depression is on the narrow side wall which is adjacent to the movable nose or is remote from the fixed nose, and the snap-action hook is disposed such that, when the installation unit is fitted, the depression snaps behind the hook nose or the hook nose snaps behind the depression.

Fixing of the installation unit and unlocking on the hat-profile rail are easily possible as a result.

In accordance with an added feature of the invention, the hat-profile carrying rail has longitudinal edges. The installation unit has a fastening side with a recess, a fixed nose, and a resiliently displaceable nose latched firmly behind the longitudinal edges of the hat-profile carrying rail. The depression formed in one of the narrow side walls is adjacent to the resiliently displaceable nose. The snap-action hook is integrally formed on the carrier plate such that the installation unit is fitted on the hat-profile carrying rail and the snap-action hook is latched into the depression.

In accordance with an additional feature of the invention, the carrier plate has a longitudinal edge and a width corresponding to a spacing between the narrow side walls of the installation unit. The resilient snap-action hook has a Z-shaped configuration with a leg integrally formed on the longitudinal edge of the carrier plate and a web, and the nose is integrally formed on the web.

In accordance with another feature of the invention, the installation unit has a housing with two shell-shaped housing parts, and the depression is formed in one of the housing parts.

In accordance with a further feature of the invention, the carrier plate has a width that is greater than a spacing between the narrow side walls of the installation unit. The snap-action hook has an L-shape with a first leg formed perpendicularly to the carrier plate and bears the nose and a second leg, extending parallel to the carrier plate, and runs in a direction away from the installation unit.

In accordance with a concomitant feature of the invention, the snap-action hook has a further leg oriented away from the hat-profile carrying rail and has, on a side opposite to the carrier plate, a groove formed therein running parallel to the hat-profile rail and serves for accommodating a tool.

Other features which are considered as characteristic for the invention are set forth in the appended claims.

Although the invention is illustrated and described herein as embodied in a quick-fastening device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The single figure of the drawing is a perspective view of an installation unit snapped onto a carrier configuration according to the invention.

### DESCRIPTION OF THE PREFERRED EMBODIMENTS

Referring now to the single figure of the drawing in detail, there is shown a carrier configuration 10 that is made up of a carrier plate 11 and of a hat-profile rail 12 fastened thereon. The hat-profile rail 12 is a structural element that is known per se. It has a web 13 and two legs 14 and 15 running parallel to the web 13. Fitted on the carrier configuration 10 is an installation unit 16 which has—usually—on its fastening surface 17 a recess 18 which, on the left-hand side, has a fixed nose 19 which forms a V-shaped undercut. One leg of the V-shaped undercut opens out into a base side 20 of the recess 18. The opposite boundary of the recess 18 is formed by a boundary wall 21. It is possible to provide, within the installation unit 16, a movable nose, which in this case has been left out and/or is not necessary. Such a movable nose is likewise usually to be found in each installation unit.

An approximately Z-shaped snap-action hook 40 is integrally formed on a longitudinal edge 22, running parallel to the hat-profile carrying rail 12, of the carrier plate 11. To be precise, the snap-action hook 40 is on the side that is adjacent to the boundary wall 21. A first leg 23 of the snap-action hook 40 runs perpendicularly to the longitudinal edge 22 and in a direction of the plane of the carrier plate 11. Integrally formed on the leg 23 is a web 24, which runs perpendicularly to the longitudinal edge 22 and to the plane of the carrier plate 11. A free end of the web 24 bears a second leg 25, which runs parallel to the first leg 23, and on its surface 27, which is directed toward a front side 26, has a groove 28 in which, for example, a tool can engage.

On its narrow side 29 located adjacent to the boundary wall 21, the installation unit 16 has a depression 30, in which a nose 31 on the web 24 can engage. The depression 30 has a leg surface 32 that runs approximately parallel to the fastening plane and behind which a nose surface 33, which is directed toward the web 24, can latch.

The drawing depicts the installation unit 16 in a state in which it has been latched onto the hat-profile carrying rail 12. For fitting purposes, the installation unit 16 is hooked in, by way of the fixed nose 19, behind the leg 14 of the carrying rail 12. Then the installation unit is pivoted in a clockwise direction U, about an axis of rotation formed by the longitudinal edge of the leg 14, until the surface 20 of the recess 18 rests on the leg 15 and the nose 31 has latched into the depression 30.

For removal purposes, a tool, for example a screwdriver which is inserted into the groove 28, is used in order to bend up the snap-action hook 23 resiliently in the clockwise direction U, with the result that the nose 31 is freed from the depression 30 and the installation unit 16 can be removed.

The housing of the installation unit is formed from two shell-shaped housing parts 34 and 35; the depression 30 is located in the side wall of the housing part 35. It is, of course, possible for the depression 30 to be selected such that it may also be located in other housing parts 34 or centrally in the region of a joint 36 separating the two housing parts 34 and 35.

I claim:

1. A quick-fastening device, comprising:
an installation unit having narrow side walls with a depression formed in one of said narrow side walls;
a carrying-rail configuration having a carrier plate and a hat-profile rail fastened on said carrier plate; and
a resilient snap-action hook integrally formed on said carrier plate, said resilient snap-action hook having a nose oriented in a direction of said hat-profile carrying rail and snaps in behind said depression in said installation unit.

2. The quick-fastening device according to claim 1, wherein:
said hat-profile carrying rail has longitudinal edges;
said installation unit has a fastening side with a recess formed therein, a fixed nose, and a resiliently displaceable nose latched firmly behind said longitudinal edges of said hat-profile carrying rail, said depression formed in one of said narrow side walls is adjacent to said resiliently displaceable nose; and
said snap-action hook is integrally formed on said carrier plate such that said installation unit is fitted on said hat-profile carrying rail and said snap-action hook is latched into said depression.

3. The quick-fastening device according to claim 1, wherein:
said carrier plate has a longitudinal edge and a width corresponding to a spacing between said narrow side walls of said installation unit; and
said resilient snap-action hook has a Z-shaped configuration with a leg integrally formed on said longitudinal edge of said carrier plate and a web, and said nose is integrally formed on said web.

4. The quick-fastening device according to claim 1, wherein said installation unit has a housing with two shell-shaped housing parts, and said depression is formed in one of said housing parts.

5. The quick-fastening device according to claim 1, wherein:
said carrier plate has a width which is greater than a spacing between said narrow side walls of said installation unit; and
said snap-action hook has an L-shape with a first leg formed perpendicularly to said carrier plate and bears said nose and a second leg, extending parallel to said carrier plate, and runs in a direction away from said installation unit.

6. The quick-fastening device according to claim 3, wherein said snap-action hook has a further leg oriented away from said hat-profile carrying rail and has, on a side opposite to said carrier plate, a groove formed therein running parallel to said hat-profile rail and serves for accommodating a tool.
